(19) United States
(12) Patent Application Publication
(10) Pub. No.: US 2024/0217357 A1
(43) Pub. Date: Jul. 4, 2024

(54) IN FLIGHT ELECTRICAL CHARGING SYSTEM AND METHOD FOR A BATTERY POWERED AIRCRAFT

(71) Applicant: Airbus Operations S.L.U., GETAFE (ES)

(72) Inventor: Carlos CASADO MONTERO, GETAFE (ES)

(21) Appl. No.: 18/520,186

(22) Filed: Nov. 27, 2023

(30) Foreign Application Priority Data
Dec. 28, 2022 (EP) 22383308.8

(51) Int. Cl. B60L 53/18; B60L 53/30; B60L 53/60

(52) U.S. Cl. CPC B60L 53/18; B60L 53/30; B60L 53/60; B60L 2200/10; B64U 2101/00

(57) ABSTRACT

An in-flight electrical charging system and method for a battery-powered aircraft located in a charging aircraft and including an electrical generation module including a turbine, an electric generator in electrical connection to the turbine for generating electricity, a turbine control unit in connection with the turbine and controlling it, and an electric generator control unit in connection with the electric generator and controlling it, a deployable power supply module, in electrical connection to the electrical generation module and including at least a cable configured for the electrical connection of the electrical generation module to the battery-powered aircraft to be charged, a pod configured to be applied to the charging aircraft, wherein the electrical generation module and the deployable power supply module are located within the pod.

### CROSS-REFERENCES TO RELATED APPLICATIONS

This application claims the benefit of the European patent application Ser. No. 22/383,308.8 filed on Dec. 28, 2022, the entire disclosures of which are incorporated herein by way of reference.

### FIELD OF THE INVENTION

The invention relates to a system and a method for transferring electric power to a battery-powered aircraft for the purpose of battery recharging. The present invention provides for increasing the power reserve of an electrically propelled aircraft via an in-flight recharging process.

### BACKGROUND OF THE INVENTION

Aerial electric vehicles are known. Small aircraft and drones have been powered electrically in the past years.

One of the well-known problems of this technology is the limited flight time that batteries offer. It is known that requiring an aircraft to land and charge mid-flight can be costly in terms of time and money. It can cause delays in executing a mission and may also be inconvenient or impractical. It is, therefore, advantageous to provide a system for aerial recharging of an electric aircraft.

Nowadays, piloted aircraft and in-flight refueling is widely used for fuel-powered aircraft. A tanker aircraft acts as refueller for a receiving aircraft. The refueller is generally an airplane with high capacities to have the maximum fuel available for the aircraft that meet it. The refueller drags behind it an in-flight refueling device which can take two different forms: either a rigid boom which will be controlled from the refueling aircraft, or a basket at the end of a flexible hose in which the aircraft to be refueled will be refueled via a refueling boom.

Unmanned aerial vehicles (UAV) are becoming more important, specifically electric unmanned aerial vehicles (UAVs). Electric propulsion has a minimum acoustic and thermal footprint, a key feature for military and civil application. Although batteries may be, therefore, a driver for tactical unmanned aerial systems (UAS) electrification transition, as previously explained, batteries have the drawback of their limited flight time. Thus, a recharging system may enlarge their operability by loading them electrically.

### BACKGROUND OF THE INVENTION

It is an object of the present invention to provide an in-flight electrical charging system for a battery-powered aircraft. The system is configured to be located in a charging aircraft and it comprises:

an electrical generation module comprising:

a turbine, for instance, a ram turbine,

an electric generator in electrical connection to the turbine for generating electricity,

a turbine control unit in connection with the turbine and configured for controlling the turbine, and

an electric generator control unit in connection with the electric generator and configured for controlling the electric generator,

a deployable power supply module, in electrical connection to the electrical generation module and comprising at least a cable configured for the electrical connection of the electrical generation module to the battery-powered aircraft to be charged,

a pod configured to be applied to the charging aircraft, wherein the electrical generation module and the deployable power supply module are located within the pod.

It should be noted that the designation of “charging aircraft” in this context is provided by way of illustrative example, only. The nature of the aircraft need not be fixed, it may be a drone, an airplane, a helicopter, etc.

For the purposes of this disclosure, the term “battery-powered aircraft” shall be taken to include aircraft that have at least one battery and at least one electric motor as any portion of their propulsion design, such as all-electric or hybrid-electric aircraft.

By aircraft, the disclosure refers to planes and drones being manned or unmanned, regardless of their size.

The charging aircraft need not necessarily be an electric aircraft. The charging aircraft could be any type of fuel powered aircraft or electric aircraft (hybrid or fully electrical) with the portable and modular charging system object of the invention.

According to the above, the claimed system comprises a turbine, for instance, a ram turbine, which generates power from the airstream based on the speed of the charging aircraft and which is connected to the electric generator which transforms the motion of the ram turbine into electricity.

A ram turbine is a Ram Air Turbine (RAT), a wind turbine that is installed in an aircraft and usually used as an alternate or emergency hydraulic or electrical power source.

One of the main advantages of the invention is its modularity, providing within a single component, a pod, all the functionalities of the power system. Therefore, the system of the invention may comprise a simple interface with the aircraft without the need for additional connections. This allows that the system may be certified independently of the electrical network or the fuel network of the aircraft.

Thus, the system object of the invention works independently from the aircraft, except for the command orders, for instance, to retract the cable, etc., but otherwise autonomous or independent of the aircraft's generation sources.

The system comprises a control unit for the turbine, within the pod, for instance for opening and closing the inlets and outlets of the turbine. It also comprises a control unit for the electric generator within the pod. They can be implemented in the same controlling unit or in two different controlling units.

The deployable power supply module comprises another control unit. The control of the deployable power supply module may be fully or partially automatic or controlled manually or partially by crew members but always with a priority of crew member control.

Therefore, the electrical generation is independent from the generation and distribution aircraft network. As previously stated, this is mainly due to the fact that the generation of electrical power is based on a turbine, for instance, a high-speed ram turbine, thus, no fuel charged or electrical input from the aircraft is to be used.

Moreover, the system object of the invention is installed into a pod, i.e., a protective housing having a streamlined shape located under the wings or the fuselage of the aircraft.

The claimed invention is, therefore, a modular element with a minimum interface with the charging aircraft. As previously stated, it is also a self-power electrical generator system, without power supply from the charging aircraft. Thus, the main advantages of the system are that it is an autonomous integrated system.

The in-flight electrical charging system located in the pod has an electrical connection with the charging aircraft and it is configured to receive instructions from the charging aircraft. However, the control unit of the system is located within the pod. It may comprise its own battery. Thus, as the interface of the system with the charging aircraft is restricted to a minimum, it is easily adaptable to any aircraft. Moreover, as the system is modular in the sense that its relevant elements are located within the pod, the system may be allocated to an aircraft for a specific mission and removed for other purposes or missions.

The deployment of the power supply module will be able to be commanded from the cockpit or from another panel inside the aircraft. Likewise, if there is a failure, the pilot or someone from the flight crew, can control the cancellation of the operation or another safety measure. Therefore, it is required that the pilot or someone from the aircraft can command, control and monitor the deployable power supply module. Input and output signals are needed to command the action.

The power supply system of the module can be adapted to the power quality of the aircraft to be recharged.

In addition, the system is compatible with other mission modules.

The claimed invention would allow tactical unmanned aerial vehicles (UAV) within a tactical unmanned aerial systems (UAS) having a non-time limited operation. This will open new and extended operation market for unmanned aerial systems (UAS) having in mind today's technical features or limitations of unmanned aerial systems (UAS), future trend for mission-enhanced and environmental unmanned aerial systems (UAS).

An electrical charging in flight system will complement the reduce flight time of batteries, increasing the pay-load ratio and enhancing to a no-time limited system, with a non-stop operation, overall, when thinking in tactical UAS/UAV swarm.

Moreover, the invention avoids the need to develop a dedicated unmanned aerial vehicles (UAV) for performing the charging operation. The invention allows its accommodation to any aircraft, for instance, a plane unmanned aerial vehicles (UAV) that integrates the claimed charging system in a pod. Therefore, the claimed invention is flexible, it is compatible with wider types of existing unmanned aerial systems (UAS). By doing this, the system is not constrained to one single source, but to a more open market.

It is also an object of the present invention to provide a pod of an aircraft comprising an electrical charging in-flight system according to the described above.

The pod is configured to be applied to the charging aircraft and comprises an in-flight electrical charging system comprising:

an electrical generation module comprising:

a turbine,

an electric generator in electrical connection to the turbine for generating electricity,

a turbine control unit in connection with the turbine and configured for controlling the turbine, and

an electric generator control unit in connection with the electric generator and configured for controlling the electric generator,

a deployable power supply module, in electrical connection to the electrical generation module and comprising at least a cable configured for the electrical connection of the electrical generation module to the battery-powered aircraft to be charged,

wherein the electrical generation module and the deployable power supply module are located within the pod.

It is also a further object of the present invention to provide an aircraft, specifically a charging aircraft, which comprises an in-flight electrical charging system according to the described above or a pod according to the above described.

It is also an object of the present invention to provide a method for in-flight electrical charging for battery-powered aircraft, comprising the following steps:

generating electricity in an electrical generation module located within a pod of a charging aircraft, the electrical generation module comprising:

a turbine,

an electric generator in electrical connection to the turbine for generating electricity,

a turbine control unit in connection with the turbine and configured for controlling the turbine and a generator control unit in connection with the generator and configured for controlling the generator,

approaching the battery-powered aircraft to the charging aircraft,

deploying a cable from a deployable power supply module located within the pod of the charging aircraft, the deployable power supply module being in electrical connection with the electrical generation module, the cable electrically connecting the electrical generation module with the battery-powered aircraft,

bringing the deployed cable into contact with the battery-powered aircraft and charging it.

### BRIEF DESCRIPTION OF THE DRAWINGS

To complete the description and to provide for a better understanding of the invention, a set of drawings is provided. The drawings form an integral part of the description and illustrate preferred embodiments of the invention. The drawings comprise the following figures.

FIG. 1 shows a schematic cross-sectional lateral view of a pod and an embodiment of the in-flight electrical charging system of the invention.

FIG. 2 shows an aircraft with a pod according to an embodiment of the invention.

### DETAILED DESCRIPTION OF THE PREFERRED EMBODIMENTS

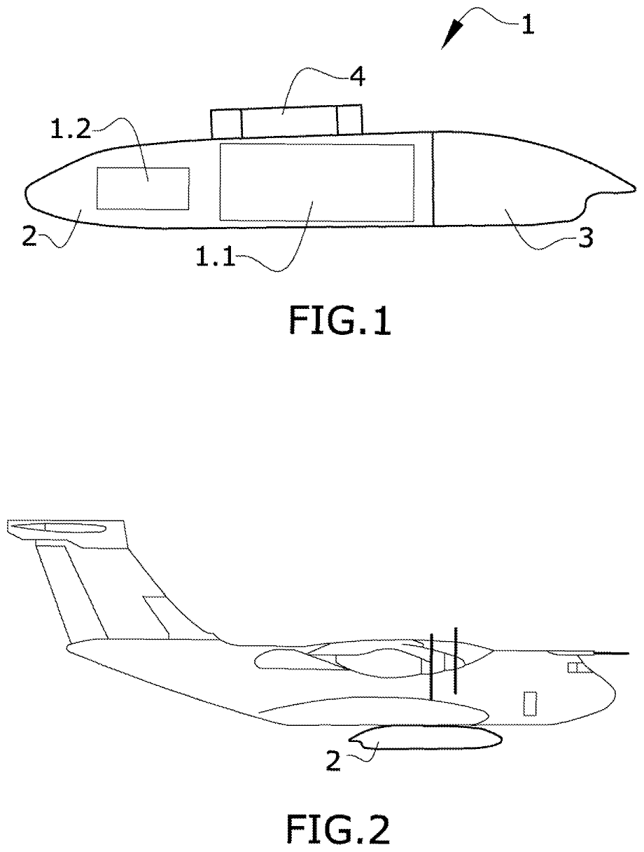

FIG. 1 discloses an embodiment of the in-flight electrical charging system object of the invention. The system comprises:

an electrical generation module (1) comprising:

the ram turbine (1.1),

the electric generator (1.2) electrically connected to the ram turbine (1.1) for generating electricity,

the turbine control unit in connection with the ram turbine (1.1) and configured to control the ram turbine (1.1), and

a generator control unit in connection with the electric generator (1.2) and configured to control the electric generator (1.2),

the deployable power supply module (3), in electrical connection to the electrical generation module (1) and comprising at least a cable, electric cable, configured for the electrical connection of the electrical generation module (1) with the battery-powered aircraft to be charged,

a pod (2) applied to the charging aircraft wherein the electrical generation module (1) and the deployable power supply module (3) are located within the pod (2).

The charging aircraft may have a cable or a boom comprising a cable that can be extended to electrically engage a battery-powered aircraft. The charging aircraft may have multiple such booms or cables, so that multiple battery-powered aircraft can be recharged at one time.

The cable comprises an electrical connection to the aircraft to be charged. It must be flexible since a swarm could comprise two unmanned aerial vehicles (UAVs) or many more, therefore able to:
supply power to one or several unmanned aerial vehicles (UAV) simultaneously, and/or
supply a sequenced unmanned aerial vehicles (UAV) charging.

In an embodiment, the electric generator (1.2) may be a direct shaft driven generator, therefore there is no need for a gearbox. It may be a high-speed generator (12000 rpm to 35000 rpm), high efficiency generator, air cooled with inverter/rectifier installed providing a high-voltage direct current (HVDC). However, it would be possible to adapt the system to a different voltage.

The in-flight electrical charging system may comprise an interface (4) with the charging aircraft comprising a supply output to the charging aircraft such that the turbine control unit in connection with the ram turbine (1.1) and configured for controlling the ram turbine (1.1) opens and closes the inlets and outlets of the ram turbine (1.1).

The system may in addition, comprise a battery for ram turbine (1.1) actuation that opens the inlets and outlets of the ram turbine (1.1). Two options can be considered: that it is located onboard the charging aircraft and provides power to the aircraft or, alternatively, that a dedicated battery is installed inside the pod (2) that allows this operation to be autonomous that would be powered or charged by the ram turbine (1.1) once operational.

The system may comprise a mini electric generator as back-up system.

In an embodiment, the system further comprises a cooling system located within the pod (2). For instance, an air-oil cooled integrated into the electrical module.

In an embodiment, the system comprises an interface (4) with the charging aircraft, the interface (4) comprising an input/output signals bus data for controlling the deployable power supply module (3) and an electrical output to the charging aircraft.

More specifically, the in-flight electrical charging system comprises an interface (4) with one single bus data (TBC) and one single electrical high-voltage direct current (HVDC) output. The control and monitoring interface may comprise a bus data of different types and it can be single or double. The commands are redundant for safety.

In an embodiment, the electrical generation module comprises at the pod (2):

A control/monitoring unit for the power generator (1.2).

A control/monitoring unit for the turbine (1.1), for instance, air or ram turbine (1.1).

Both units may be accommodated into one single unit comprising both controls.

In addition, a control/monitoring unit for the deployable power supply module (3) can be devised located in the aircraft.

It also comprises a power inlet supply for the above controllers.

In an embodiment, the electrical generation module comprises two supply outputs: one for the deployable power supply module (3) and one for the aircraft supply located in the interface (4) of the system.

The deployable power supply module (3) may comprise a rigid boom with a cable or a flexible cable having on the end, for instance, a charging jack that is configured to engage a charging port on the battery-powered aircraft to be charged. It may also comprise a known cable stability when deployed based on existing refueling systems.

The invention does not relate on the technology for electrical charging. It is assumed that electrical charging is easier than refueling. The charging may be at High Voltage DC, which has a smaller cable sizing and with a direct loading to batteries without being treated at the unmanned aerial vehicles (UAV).

The systems and devices described herein may include a controller, control unit, such as the control/monitoring unit for the power generator (1.2), the control/monitoring unit for the turbine (1.1), control device, the control/monitoring unit for the deployable power supply module (3), controlling means, system control, processor, computing unit or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. In-flight electrical charging system for a battery-powered aircraft, the in-flight electrical charging system being configured to be located in a charging aircraft, the in-flight electrical charging system comprising:
an electrical generation module comprising:
a turbine,
an electric generator in electrical connection to the turbine for generating electricity,
a turbine control unit in connection with the turbine and configured to control the turbine, and
an electric generator control unit in connection with the electric generator and configured to control the electric generator,
a deployable power supply module, in electrical connection to the electrical generation module and comprising at least a cable configured to electrically connect the electrical generation module to the battery-powered aircraft to be charged,
a pod configured to be applied to the charging aircraft,
wherein the electrical generation module and the deployable power supply module are located within the pod.

2. The in-flight electrical charging system for a battery-powered aircraft, according to claim 1, wherein the in-flight electrical charging system comprises an interface with the charging aircraft, the interface comprising an input/output signals bus data configured to control the deployable power supply module and an electrical output to the charging aircraft.

3. The in-flight electrical charging system for a battery-powered aircraft, according to claim 1, wherein the deployable power supply module comprises several cables configured to electrically connect several battery-powered aircraft.

4. The in-flight electrical charging system for a battery-powered aircraft, according to claim 1, wherein the electric generator is a direct shaft driven generator.

5. The in-flight electrical charging system for a battery-powered aircraft, according to claim 1, wherein the in-flight electrical charging system further comprises a cooling system located within the pod.

6. The in-flight electrical charging system for a battery-powered aircraft, according to claim 1, further comprising a battery within the pod for actuation of the turbine.

7. The in-flight electrical charging system for a battery-powered aircraft, according to claim 1, wherein the turbine is configured to generate power from an airstream surrounding the charging aircraft based on a speed of the charging aircraft.

8. A pod of an aircraft, configured to be applied to a charging aircraft, comprising an in-flight electrical charging system comprising:
an electrical generation module comprising:
a turbine,
an electric generator in electrical connection to the turbine configured to generate electricity,
a turbine control unit in connection with the turbine and configured to control the turbine, and
an electric generator control unit in connection with the electric generator and configured to control the electric generator,
a deployable power supply module, in electrical connection to the electrical generation module and comprising at least a cable configured for the electrical connection of the electrical generation module to a battery-powered aircraft to be charged,
wherein the electrical generation module and the deployable power supply module are located within the pod.

9. An aircraft comprising an in-flight electrical charging system according to claim 1.

10. A method for in-flight electrical charging for battery-powered aircraft, comprising the following steps:
generating electricity in an electrical generation module located within a pod of a charging aircraft, the electrical generation module comprising:
a turbine,
an electric generator in electrical connection with the turbine to generate electricity,
a turbine control unit in connection with the turbine and configured to control the turbine, and
a generator control unit in connection with the electric generator and configured for controlling the electric generator,
approaching the battery-powered aircraft to the charging aircraft,
deploying a cable from a deployable power supply module located within the pod of the charging aircraft, the deployable power supply module being in electrical connection with the electrical generation module, the cable electrically connecting the electrical generation module with the battery-powered aircraft,
bringing the deployed cable into contact with the battery-powered aircraft and charging the battery-powered aircraft.
